(19) United States
(12) Patent Application Publication
(10) Pub. No.: US 2002/0063977 A1
(43) Pub. Date: May 30, 2002

(54) Adjusting device for motor vehicle outside mirrors

(76) Inventors: Werner Seichter, Georgensgmuend (DE); Richard Guttenberger, Greding (DE)

Correspondence Address: JACOBSON HOLMAN PLLC, 400 SEVENTH STREET N.W., SUITE 600, WASHINGTON, DC, 20004, US

(21) Appl. No.: 09/989,137

(22) Filed: Nov. 21, 2001

(30) Foreign Application Priority Data
Nov. 25, 2000 (DE) 100 58 724.0

(51) Int. Cl. B60R 1/02; A47G 1/24; G02B 7/182

(52) U.S. Cl. 359/877; 359/876; 248/476

(57) ABSTRACT

Adjusting device for the outside mirror of a motor vehicle, comprising a drive housing, on which is mounted by means of a central ball and cap bearing a mirror glass carrier, which is provided preferably with intersecting metal toothed strips, chains or the like, which, enveloping the shell-like drive housing, are in engagement with the output toothed gears of two drive motors, disposed in the drive housing, and comprising a line feed-through, which is designed preferably as a feed-through plug and belongs to the drive housing, for connecting the electrical consuming devices to the outer current and control lines, whereby the line feed-through is molded to an adapter element, which can be inserted into a recess of the drive housing and which preferably closes said drive housing so as to seal.

### BACKGROUND OF THE INVENTION

(1) Field of the Invention

The invention relates to an adjusting device for the outside mirror of a motor vehicle that includes a drive housing, in general, and to adaptor elements for use with the drive housing to allow the drive housing structure to be used with several different types of feed-through plugs, in particular.

(2) Description of Related Art

The present invention is used in a device for the outside mirror of a motor vehicle. The device is made up of a drive housing, on which is mounted by means of a central ball and cap bearing a mirror glass carrier. Intersecting metal toothed strips, chains or the like envelope the shell-like drive housing and are in engagement with output toothed gears of two drive motors, disposed in the drive housing. The drive housing has a feed-through plug that belongs to the drive housing, for connecting electrical consuming devices within the drive housing to outer current and control lines.

A significant problem with such adjusting devices is the design of the line feed-through, especially in the form of a feed-through plug, since the car industry needs many different types of adjusting devices in order to accommodate various internal devices found in the drive housing. Among the internal devices are adjusting motors, mirror heating or mirror dimming devices or other additional devices, such as devices for merging the distance of a range finder into the mirror. This means that for each purpose there must be an inventory of different drive housings, which are provided with feed-through plugs having a varying number of electrical connection pins and different designs, for example sealed or unsealed.

Therefore, the invention is based on the problem of designing an adjusting device of the aforementioned class in such a manner that with very simple means and without great complexity, different application purposes can be accomplished and especially the varying number and types of line feed-throughs can be accommodated.

### BRIEF SUMMARY OF THE INVENTION

The invention provides a solution to this problem in that the line feed-through is molded to an adapter element, which can be inserted into a recess defined in the drive housing and which preferably closes the drive housing so as to seal it, whereby the recess is designed preferably in such a manner that all inside electrical connecting contacts in the drive housing are accessible from the top through the recess.

The inventive design makes it possible to meet different demands and to accommodate the numerous, commercially available adjusting devices or connecting variants so that one does not have to provide and produce a complete drive housing with a molded on special plug. Instead, there is a basic design with a recess formed in the drive housing, into which the suitable adapter elements, that are provided with the corresponding plug designs desired by the customer, are inserted as the occasion demands.

In a preferred embodiment of the invention, mating electrical contacts can be fastened to the adapter element. When putting on the drive housing, the mating electrical contacts automatically bring about the desired electrical connection with the inside connecting contacts. The result is an especially simple assembly, which is even significantly simpler than before, since, in the past, the plug contacts of the feed-through plug still had to be connected to the inside connecting contacts individually by means of moveable electrical lines or by means of deflector lugs. All these assembly steps can now be eliminated by providing prefabricated adapter elements with the corresponding mating electrical contacts, which, when inserted into the recess of the drive housing, implement the entire plug.

The connection of the respective adapter elements with the drive housing can be designed as a detachable connection or as a rigid nondetachable connection. In the case of a nondetachable connection, the electrical connections are made by welding or cementing. In practice a rigid connection suffices, since in the present case the goal is not to provide again at a later date access to the inside of the drive housing, but rather the goal is to avoid the provision of a plurality of drive housings exhibiting different constructions and different feed-through plugs. However, the detachable connection also has the advantage that in the event of a repair ready access is possible and it is not necessary to remove the entire adjusting device, discard it and replace it with a new one—as was usually the procedure in the past.

In the simplest case, the adapter element comprises a plate, whose shape and profiling match the wall design of the recess of the drive housing to which is molded a feed-through plug, whose permanently laid connecting lines are connected to the mating contacts on the adapter plate.

### BRIEF DESCRIPTION OF THE SEVERAL VIEWS OF THE DRAWINGS

Other advantages, features and details of the invention are disclosed in the following description of the embodiment and with reference to the following drawings:

FIG. 1 is a perspective view of the inventive adjusting device from the rear.

FIG. 2 is an exploded drawing of the adjusting device, according to FIG. 1, with the adapter element, disposed above the housing with the recess.

FIG. 3 is a top perspective view of another adapter element with additional plugs for contacting of motors, a potentiometer, a mirror heater or a mirror dimmer found in the drive housing.

FIG. 4 is a bottom perspective view of the adapter element of FIG. 3. FIG. 5 is a top perspective view of an adapter element with a different design of the feed-through plug.

FIG. 6 is a bottom perspective view of the adapter element of FIG. 5.

FIG. 7 is another top perspective view of a fourth embodiment of an inventive adapter element with a feed-through plug, designed in a water-sealed form.

### DETAILED DESCRIPTION OF THE INVENTION

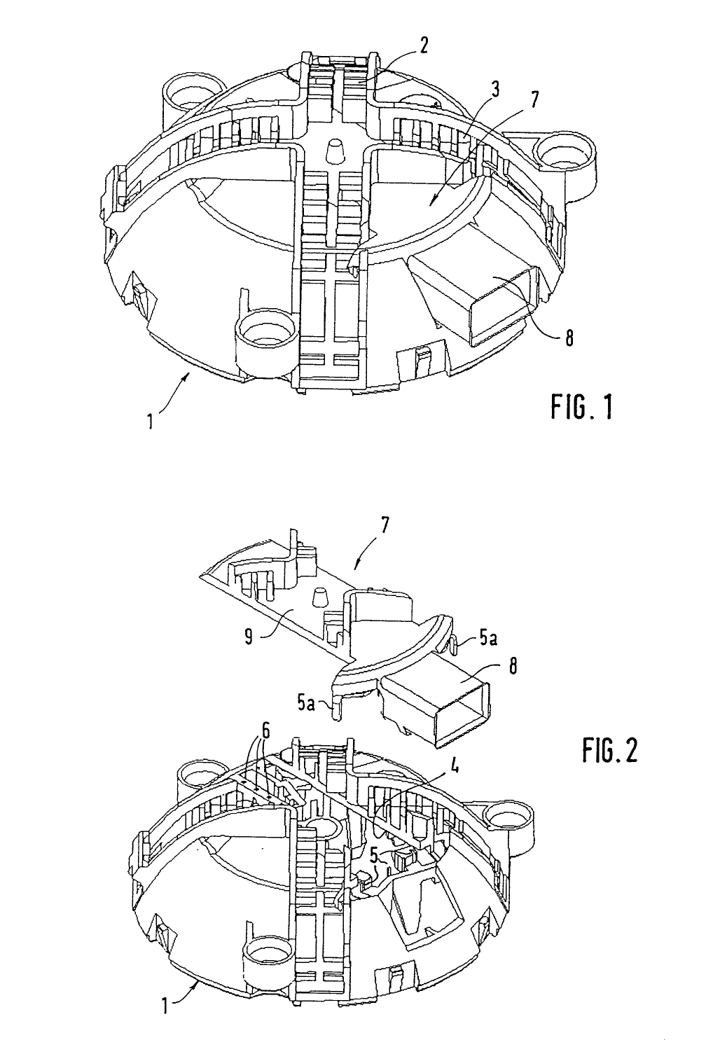

FIGS. 1 and 2 show a drive housing 1 for an adjusting device for the outside mirror of a motor vehicle, whereby a mirror glass carrier (not illustrated) is hinged to the drive housing 1 by means of a ball and cap bearing, which cannot be detected. Intersecting toothed strips are fastened to a peripheral ring wall of the mirror glass carrier. The toothed strips envelop the drive housing in the two illustrated guides 2 and 3 and, owing to their elastic design, which can also be reinforced, if desired, by additional undulations, hold together the drive housing and the mirror glass carrier. The output-toothed gears of the adjusting motors, disposed in the interior of the drive housing, mate with the toothed sections of the toothed strips, in order to swivel the mirror glass carrier about two axes that cross each other perpendicularly. Co-pending U.S. patent application Ser. No. 09/559,398, Actuating Mechanism for Motor Vehicles, is directed to an actuating mechanism that has an overall structure similar to that of the present invention but without the inventive adapter element. The application is incorporated by reference herein as if reproduced in full for the purpose of showing and explaining many of the structural details shown in FIGS. 1 and 2 of the present specification.

To obtain the electric connection of the outer electrical connecting lines with the inside electrical connections in the drive housing, the invention provides for, in the illustrated drive housing, a recess 4 in the drive housing. The recess is designed and arranged in such a manner that all internal connecting contacts 5 for the drive motors or 6 for additional functions, like potentiometers, mirror heaters and the like, are accessed, when viewed from the top, through the recess. An elongated adapter element 7 with a molded-on feed-through plug 8 for the outside electrical connecting lines is provided with a generally planar plate-shaped part 9, which matches precisely the form of the recess 4 of the drive housing so that, when the adapter element 7 is put on the driving housing, the recess 4 is completely closed and sealed again. Mating plugs 5a and optionally 6a are fastened to the adapter element 7, whereby the design is conceived in such a manner that, when putting on the adapter element 7, the mating plugs 5a, 6a automatically mate with the inside connecting contacts 5 and 6, respectively, so as to make electrical contact and thus produce the electrical connection between the feed-through plug and the inside consuming devices.

To place the recess 4 in such a manner that the aforementioned automatic electrical contacting can occur when the adapter element 7 is put on, parts of the guides 2 and 3 for the toothed strips are also cut out at the same time. The plate 9 of the adapter element 7 is identical to the corresponding wall cutout of the drive housing in shape and outer configuration. Thus, the plate is essentially nothing more than the element formed by cutting out a corresponding wall segment.

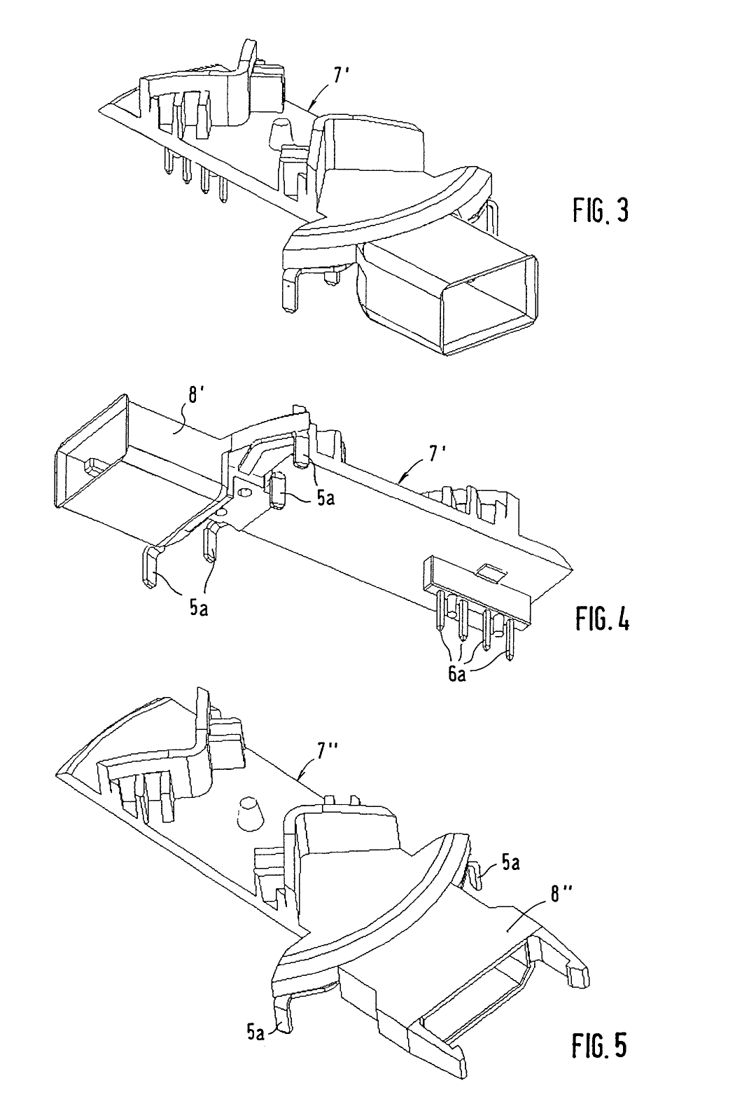

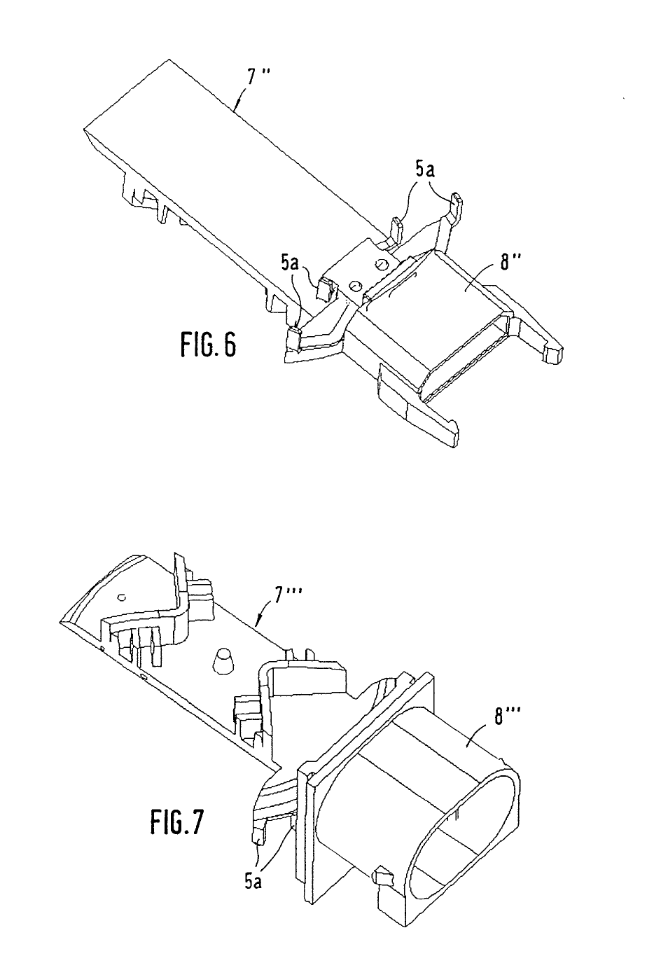

The distinction between the adapter elements 7′, 7″, and 7′″, depicted in FIGS. 3 to 7, and the adapter element 7 shown in FIG. 1 lies only in the different feed-through plugs 8′, 8″, and 8′″ and the varying number of mating plugs for the electrical connection of additional consuming devices, as already explained above. All of the various adapter elements are shaped in such a manner that they can be inserted in one and the same recess 4 of the drive housing 1, the recess being preferably sealed, whereby simultaneously upon insertion the plug connection between the contacts 5, 6 and the mating contacts 5a, 6a of the adapter element takes place.

What is claimed is:

1. An adjusting device for the outside mirror of a motor vehicle having a drive housing that contains electrical consuming devices, the adjusting device receiving power from external current provided in control lines and comprising:
a recess defined in the shell-like drive housing;
a mirror glass carrier mounted on the drive housing; and
a line feed-through, which is designed as a feed-through plug and belongs to the drive housing, for connecting the electrical consuming devices in the drive housing to the outer current and control lines, wherein the line feed-through is molded to an adapter element that is inserted into the recess of the drive housing and which preferably closes said drive housing.

2. The adjusting device, as claimed in claim 1, further comprising electrical contacts positioned inside the drive housing, and wherein the recess is designed in such a manner that all inside connecting contacts are accessible from the top of the drive housing through the recess.

3. The adjusting device, as claimed in claim 2, wherein mating contacts are fastened to the adapter element; and, when the adapter element is put on the drive housing, the mating contacts create an electrical connection between the desired plug contacting and the connecting contacts.

4. The adjusting device, as claimed in claim 1, wherein the adapter element comprises a plate whose shape and profiling match the recess of the drive housing.

5. The adjusting device, as claimed claim 1, wherein the adapter element is connected, in particular locked, to the drive housing so as to be disconnectable.

6. The adjusting device, as claimed in claim 1, wherein the adapter element is permanently connected to the drive housing.
